(19) United States
(12) Patent Application Publication
(10) Pub. No.: US 2025/0087050 A1
(43) Pub. Date: Mar. 13, 2025

(54) PHYSICAL AND/OR DIGITAL DIAL INTERFACE FOR WAGERING KIOSK

(71) Applicant: SB22, Inc., Dallas, TX (US)

(72) Inventors: Vladimir Jovanovic, Belgrade (RS); Marko Savkovic, Belgrade (RS)

(21) Appl. No.: 18/828,757

(22) Filed: Sep. 9, 2024

Related U.S. Application Data
(60) Provisional application No. 63/537,043, filed on Sep. 7, 2023.

(51) Int. Cl. G07F 17/32

(52) U.S. Cl. CPC G07F 17/323; G07F 17/3288

(57) ABSTRACT

An exemplary gaming kiosk is disclosed herein which includes a dial in which a player is able to select a desired winning amount. Upon receiving the wager amount and the winning amount, aspects of the present disclosure generate a number of wager combinations which will pay out the desired winning amount based upon the wager amount. That is out of a set of all available wagers, aspects of the present disclosure generate one or more wagering combinations that would result in the dialed-in win amount if successful. The wagering combinations are presented to the player via the kiosk.

### CROSS-REFERENCE TO RELATED APPLICATIONS

This application claims priority to U.S. Provisional Patent Application Ser. No. 63/537,043, filed Sep. 7, 2023, entitled “DIAL INTERFACE FOR SPORTS WAGERING KIOSK,” which is incorporated herein by reference in its entirety.

### BACKGROUND

In existing sports wagering kiosks, the wager placement procedure involves a number of steps to be executed by a player in quick succession, i.e., sport selection, event selection, market selection, wager (or win) amount selection, and finally wager placement confirmation. This multi-step sequence makes it prohibitive for many of the novice sports wagering players to utilize the kiosks to their full capabilities, instead either limiting themselves to simplified selection subset, or in many cases not being able to wager at all.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to an intuitive wager placement system which can be integrated within a self-service gaming kiosk or in a system which includes one or more self-serving gaming kiosks. A gaming kiosks is operable to accept a wager amount from a player. The exemplary gaming kiosk disclosed herein includes a dial in which a player is able to select a desired winning amount. Upon receiving the wager amount and the winning amount, aspects of the present disclosure generate a number of wager combinations which will pay out the desired winning amount based upon the wager amount. That is out of a set of all available wagers, aspects of the present disclosure generate one or more wagering combinations that would result in the dialed-in win amount if successful. The wagering combinations are presented to the player via the kiosk. If the player chooses to accept the currently proposed wager, the player presses the button to indicate their acceptance and place the wager with a single action. If the player does not want to accept the proposed wager, they are able to consider a different offer by using knob rotation to scroll back and forth between available wager offers.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary wager placement system, according to aspects described herein.

FIG. 2 depicts an exemplary dial interface for placing a wager according to aspects of the present disclosure.

FIG. 3 depicts and exemplary dial interface displaying a winning amount.

FIG. 4 depicts an exemplary sports wagering kiosk which includes a dial interface and a separate display screen.

FIG. 5 is a block diagram illustrating an exemplary method for selecting a winning amount using a dial interface, such as the exemplary dial interfaces disclosed herein.

FIG. 6 is a block diagram illustrating an exemplary method for generating wagering combinations according to aspects of the present disclosure

FIG. 7 is a block diagram illustrating a method for selection of a wagering combination in accordance with the aspects disclosed herein.

FIG. 8 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

An exemplary gaming kiosk is disclosed herein which includes a dial in which a player is able to select a desired winning amount. Upon receiving the wager amount and the winning amount, aspects of the present disclosure generate a number of wager combinations which will pay out the desired winning amount based upon the wager amount. That is out of a set of all available wagers, aspects of the present disclosure generate one or more wagering combinations that would result in the dialed-in win amount if successful. The wagering combinations are presented to the player via the kiosk. If the player chooses to accept the currently proposed wager, the player presses the button to indicate their acceptance and place the wager with a single action. If the player does not want to accept the proposed wager, they are able to consider a different offer by using knob rotation to scroll back and forth between available wager offers. During the wager selection and placement process, as well as after successful wager placement, the wagering kiosk provides the player with appropriate audiovisual cues, such as kiosk monitor displaying the details of the proposed offers, historical or statistical data relevant to the offer, and different sounds being generated corresponding to rotation velocity and potential winning amount.

The disclosed gaming kiosk system, among other benefits, provides the player, in as few steps as possible, with a uniquely selected wagering offer, which upon acceptance and successful outcome would result in the player winning the amount of money they have preselected. In doing so, aspects of the present disclosure provide an intuitive, streamlined wager placement system that can be to be fully integrated with a self-service gaming kiosk or in a system which includes self-service gaming kiosks.

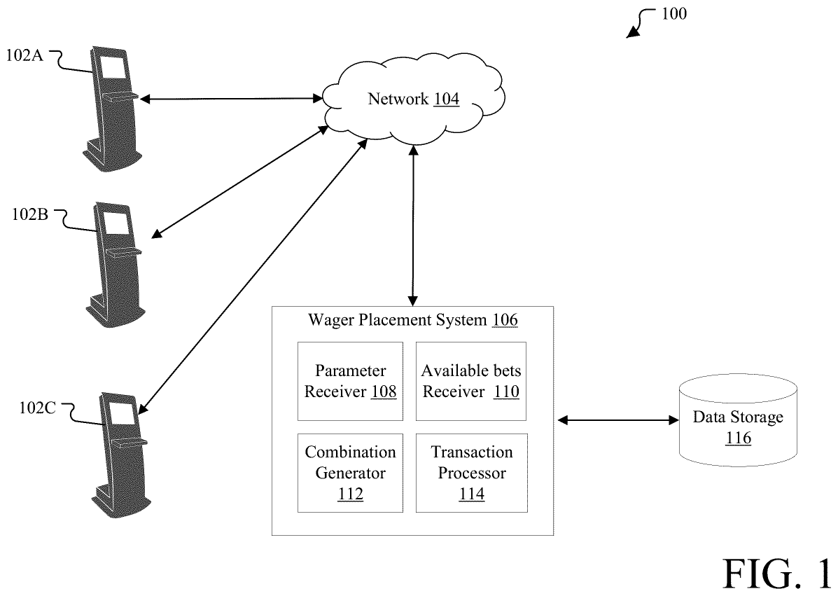

FIG. 1 depicts an exemplary wager placement system 100, according to aspects described herein. As shown in FIG. 1, a number of exemplary sports wagering kiosks 102A-102C are connected to each other and a wager placement system 106 via a network 104. Network 104 may be any type of network, such as, for example, a LAN, a WAN, a near-field communications network, a cellular broadband network, point-to-point network, a Wi-Fi network, the Internet, etc., and may include one or more of wired, wireless, and/or optical portions. In aspects, a sports wagering kiosk, such as kiosk 102A, may be any type of kiosk capable of receiving currency or credits from a player, displaying selectable betting options, and confirming and placing a wager on a selected betting option. In examples, the kiosk may be operable to receive a wager amount in the form of physical currency (e.g., paper money and/or coins), via a credit or debit/card, or digital currency (e.g., electronic bank transfers, bitcoin, etc.). The kiosk may include a payment receptacle operable to receive the wager amount. The payment receptacle may be a bill or coin acceptor, operable to receive cash or coins and identify the denominations of currency received, a credit card reader operable to read credit card magnetic strips, credit card chips, or accept credit payments using near field communication (NFC). Alternatively, or additionally, the payment receptacle may be an NFC reader able to accept payment via smartphone NFC communication. In still further aspects, the payment receptacle may be in the form of a display, for example, by displaying a QR code or other payment details that can be used to facilitate wager placement via an application on a smartphone or other device. The kiosk may also include a printer operable to print out transaction receipts, wager tickets, etc. In still further embodiments, the kiosk may include a winnings dispenser operable to read wagers (e.g., wager tickets, QR codes representing the wager, etc.) and to dispense winnings in the form of currency or a ticket which can be used to collect winnings.

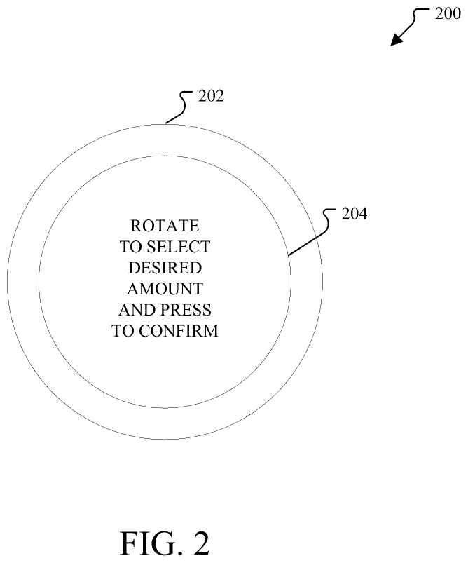

Aspects of the present disclosure provide an intuitive user interface which allows a player to easily deposit a wager amount and select a desired winning amount. In doing so, the system 100 is able to generate wager combinations which, if successful, will result in the player winning the desired amount. This allows the player to easily select wager combinations with a desired payout without the player having to evaluate the payout odds of individual bets or parlays or require the player to search for a bet or manually construct a parlay which will provide a desired payout. For example, kiosk 102A may include a physical dial which can be operated by the player to select a desired winning amount once the player has deposited their wager amount. In aspects, the physical dial may include a center display which displays an adjusted winning amount as the player turns the dial. For example, if the dial is turned clockwise, the winning amount may increase. Similarly, if the dial is turned counterclockwise, the winning amount may be decreased. Although specific interactions have been disclosed to adjust wining amounts, one of skill in the art will appreciate that different mechanisms can be used to adjust amounts, such as counterclockwise increasing amounts and clockwise decreasing amounts, physical and/or digital buttons can be used to adjust amounts, a physical or digital keypad or keyboard capable of accepting amounts, etc. Upon display of a desired winning amount, the player can press the dial down as confirmation. Exemplary dial interfaces will be described in further detail in FIGS. 2-4.

Wager placement system 106 can include a parameter receiver 108, an available bets receiver 110, a combination generator 112, and a transaction processor 114. In one aspect, the wager placement system may reside on a remote device, such as a server connected to the kiosks 102A-C. Alternatively, or additionally, the wager placement system 106 may be integrated into the individual kiosks 102A-C. In certain aspects, the parameter receiver is operable to receive the wager and the desired winning amount from the kiosk, such as kiosks 102A-C. As will be discussed in more detail, these parameters are used to generate a number of wagering combinations which, if successful, will result in the desired winning amount based upon the wager amount placed by the player. The available bets receiver 110 is operable to receive available bets from one or more datastores, such as data storage 116. That is, in aspects, the available bets receiver 110 is operable to aggregate available bets that a player can place from a number of different sources. The available bets are aggregated and, along with the wager and desired winning amount, are processed by the combination generator 112 to generate a plurality of scenarios that have the desired payout based upon the received wager amount. In some instances, the number of scenarios that result in the desired payout may be large. In said instances, the combination generator 112 may select a subset of combinations to provide to the kiosk (e.g., kiosk 102A) for display to the player. The selection of the subset may be based upon a number of different factors, including, but not limited to, the odds of the combination, the popularity of the bets included in the combinations, a player's preference (e.g., favoring combinations that include sports that the player likes), etc. Once a player selects a wagering combination, the transaction processor 114 is operable to place play the bet on the combination for the player.

Upon receiving a wager and a desired winning amount, the kiosk 102A, for example, can provide the wager and winning amount to the wager placement system 106 via network 104. In certain aspects, the wager placement system may reside on an external device, such as remote server or cloud network. Alternatively, the wager placement system may reside locally on kiosk 102A (not shown in FIG. 1). In some aspects, a printed betting ticket may be generated by the kiosk 102A upon placement of the bet by the transaction processor 114. Alternatively, or additionally, a digital confirmation may be generated and provided to the player, for example, via a sports betting application, via email, via text, etc.

FIG. 2 depicts an exemplary dial interface 200 for placing a wager according to aspects of the present disclosure. In aspects, the dial interface 200 may be a physical dial on a sports wagering kiosk. However, one of skill in the art will appreciate that the aspects disclosed herein may also be implemented using a digital interface, such as a digital dial or other type of user interface component, without departing from the scope of the disclosure. In aspects, the dial interface may include an outer portion 202 that is rotatable, and a display screen 204 (or a display area when deploying a digital interface) which is operable to display information to the player. Information displayed by the display screen 204 may include a winning amount, wagering combinations, or other types of information. In aspects, the information displayed on the display screen can be modified by turning the dial 202. For example, when displaying a winning amount, the amount may be increased when the dial is turned clockwise and decreased when the dial is turned counterclockwise (or vice versa). Once a desired amount is displayed on the display screen 204, the dial interface 200 may be pressed to select the desired winning amount. In another examples, the details of a combination wager may be displayed on the display screen 204. Turing the dial 202 may cycle through the available wager combinations. A press of the dial interface 200 may select a desired wager combination, thereby confirming placement of a bet on the wagering combination. Alternatively, or additionally, the display screen 204 may be a touchscreen. In said example, confirmation may be received via a tap on the display screen 204.

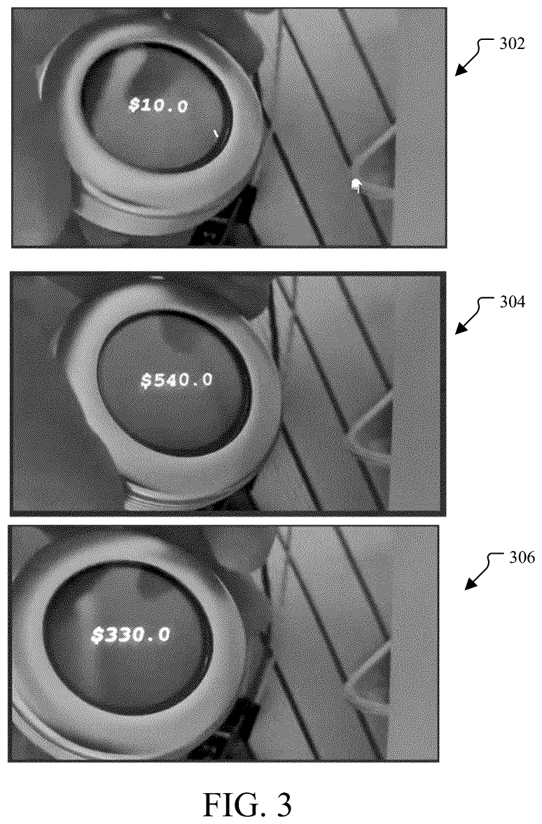

FIG. 3 depicts and exemplary dial interface displaying a winning amount. Upon placing a wager amount, the dial interface may display an initial winning amount. The initial winning amount may be predetermined. Alternatively, or additionally, the initial winning amount may be dynamically determined based upon the amount of the wager placed. As depicted at 302, an initial winning amount of $10 is shown. The winning amount may be adjusted by turning the dial around the display screen of the dial interface. For example, turning the dial amount clockwise may increase the winning amount incrementally. The increments at which the winning amount is increased may be adjusted based upon the speed that the dial is turned, the length of the dial turn, etc. As depicted at 304, the winning amount is increased to $540 upon turning the dial clockwise. Similarly, the wining amount can be decreased by turning the dial counterclockwise. For example, as depicted at 306, the winning amount is decreased to $330 from $540 when the dial is turned counterclockwise. Again, the increments at which the winning amount is decrease may be adjusted based upon the speed that the dial is turned, the length of the dial turn, etc.

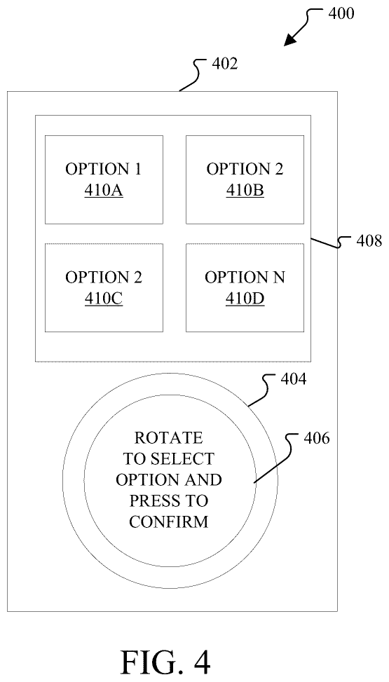

FIG. 4 depicts an exemplary sports wagering kiosk 402 which includes a dial interface and a separate display screen 408. The dial interface may include a dial 404 and a dial display screen 406 and operate as described with respect to the dial interface 200 described in FIG. 2. For ease of use, it may be beneficial to display a desired winning amount to the player on the dial display screen 406. Alternatively, or additionally, the desired winning amount can also be displayed on the kiosk display screen 408. However, in some situations, there may be too much information for display on the dial screen 406. For example, the wagering combinations may be too large to display on the dial display screen 406. In such a situation, a number of different wagering combinations, e.g., OPTION 1 410A, OPTION 2 410B, OPTION 3 410C, OPTION N 410D, may be displayed on the kiosk display screen 408. In said example, a currently selected wagering combination may be displayed on the dial display screen 406 along with a more detailed description of the currently selected wagering combination being displayed on the kiosk display screen 408. The options may be selected using the dial. For example, turning the dial may highlight and cycle through the displayed options on the kiosk display screen 408. A highlighted option may be selected by pressing down on the dial interface, thereby placing the wager on the selected wagering combination. Alternatively, or additionally, the kiosk display 408 may be a touchscreen. In such circumstance, the player may cycle through and select the wagering combination via the touchscreen interface.

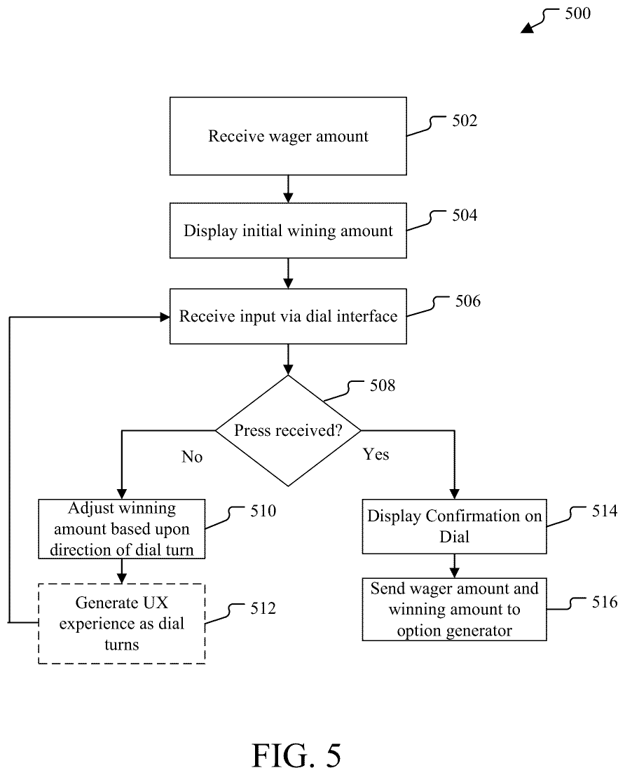

FIG. 5 is a block diagram illustrating an exemplary method 500 for selecting a winning amount using a dial interface, such as the exemplary dial interfaces disclosed herein. Flow begins at operation 502 where a wager amount is received. In examples, the wager amount may be received physically, for example, by depositing physical currency at a sports wagering kiosk, reading a credit or debit card at the kiosk, etc. Alternatively, or additionally, the wager may be received digitally, for example by receipt of digital currency, a bank transfer, etc. Upon receiving the currency, flow continues to operation 504, where an initial winning amount is displayed. In one example, the initial winning amount may be a predetermined winning amount. Additionally, or alternatively, the initial winning amount is determined based upon the wager amount received at operation 502.

At operation 506, input is received via the dial interface. In examples, the received input may be a clockwise turn, a counterclockwise turn, or a dial press. Flow continues to decision operation 508 where it is determined whether the received input is a dial press. If the input is not a press, flow branches No to operation 510. At operation 510, the winning amount is adjusted based upon the direction of the dial turn. For example, a clockwise turn will increase the winning amount and a counterclockwise turn will decrease the winning amount. At optional operation 510, a user experience may be generated as the dial is turned. For example, the color of the display can change, sounds can be played, graphics can be displayed on the dial scree and/or kiosk screen, etc. as the winning amount is increased or decreased. Flow then returns to operation 506 where additional input is received via the dial interface.

Returning to decision operation 508, if the input received from the dial interface is a press, flow branches yes to operation 514. At operation 508, a confirmation of the winning amount is displayed to the player. The confirmation can be displayed on the dial interface display and/or the kiosk display. Flow continues to operation 516 where the wager amount and the desired winning amount is provided to the wager combination generator.

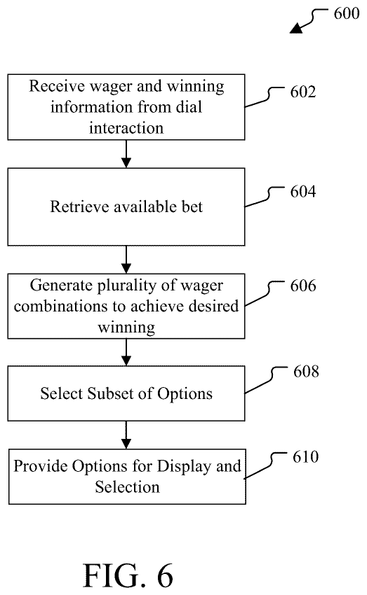

FIG. 6 is a block diagram illustrating an exemplary method 600 for generating wagering combinations according to aspects of the present disclosure. Flow begins at operation 602 where the wager information and the desired winning amount is received from the sports wagering kiosk. Flow continues to operation 604, where available bets are retrieved from one or more data sources. For example, the available bets can be received from different wagering platforms which support different sports, from different sports books, etc.

At operation 606, the available bets are analyzed against the wagered amount and the desired winning amount to generate a plurality of wagering combinations which will, if successful, payout the desired winning amount. As previously discussed, the number of combination which will pay out the desired winning amount may be very large. As such, at operation 608, a subset of wagering combination is determined from the plurality of wagering combinations. The selection of the subset may be based upon a number of different factors, including, but not limited to, the odds of the combination, the popularity of the bets included in the combinations, a player's preference (e.g., favoring combinations that include sports that the player likes), etc. The player's preference may be determine based upon a player profile, player history, or other information about the player that the player has agreed to allow to be tracked or otherwise provided. Flow continues to operation 610 where the subset of wagering combinations is provided for display, for example, by the sports wagering kiosk.

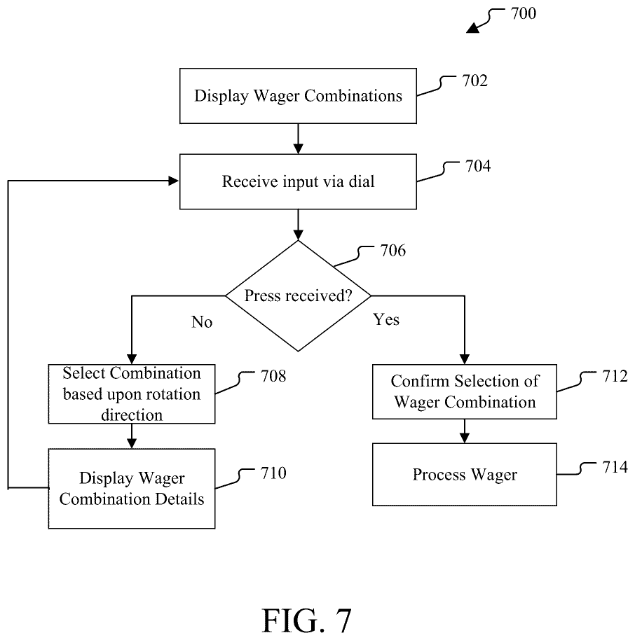

FIG. 7 is a block diagram illustrating a method 700 for selection of a wagering combination in accordance with the aspects disclosed herein. In aspects, the method 700 may be employed via use of a physical or digital interface. Flow begins at operation 702, where a number of different wagering combinations are displayed, for example, by a sports wagering kiosk. The wagering combinations can be displayed on a display attached to the kiosk and/or on the dial interface display. At operation 704, input is received via the dial interface, either physical or digital. In examples, the received input may be a clockwise turn, a counterclockwise turn, or a dial press. Flow continues to decision operation 706 where it is determined whether the received input is a dial press. If the input is not a press, flow branches No to operation 708.

At operation 708, a wagering combination is selected based upon the direction of the dial rotation. As previously discussed, a plurality of wagering combinations may be generated and displayed in accordance with aspects described herein. Via the dial interface, the player can cycle through the different wagering combinations. The combination highlighted when the dial stops turning is selected and the details of the wager combination is displayed at operation 710. Flow returns to operation 704 from operation 710 where additional input is received via the dial.

Returning to operation 706, if the dial input is a press, for example, by pressing down on a physical dial or by pressing or tapping a digital dial displayed on a touchscreen, flow branches yes to operation 712. At operation 712, the selected wager combination is confirmed for placement of the wager. Upon receiving confirmation, flow continues to operation 714 where the wager is processed on the selected wager combination. Processing the wager may include submitting the wager to the sports wagering system and providing physical (e.g., a ticket) and/or digital confirmation of the wager to the player.

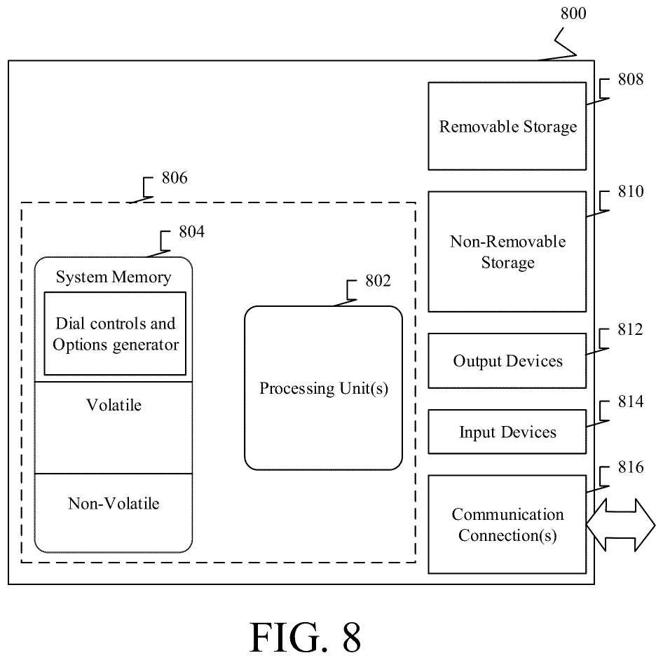

FIG. 8 illustrates a simplified block diagram of a device with which aspects of the present disclosure may be practiced, according to aspects described herein. The device may be a mobile computing device or a VR device for example. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 (instructions to perform for performing the aspects disclosed herein) may be volatile (such as RAM), non-volatile (such as ROM, flash memory, etc.), or some combination of the two. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as remote controller, keyboard, mouse, pen, voice input, on-board sensors, etc. and/or output device(s) 812 such as a display, speakers, printer, motors, etc. Also included in the environment may be one or more communication connections, 816, such as LAN, WAN, a near-field communications network, a cellular broadband network, point-to-point, etc.

Operating environment 800 typically includes at least some form of computer readable media. Computer readable media can be any available media that can be accessed by the at least one processing unit 802 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A kiosk comprising:
a dial interface, wherein the dial interface is operable to:
receive a wager amount via a turn of the dial interface, wherein receiving the wager amount comprises:
increasing the wager amount when the dial interface is turned a first direction; and
decreasing the wager amount when the dial interface is turned a second direction;
receive confirmation of a wager amount, wherein receiving confirmation of the wager amount comprises receiving a first push at the dial interface;
in response to receiving the wager amount, receive a winning amount, wherein receiving the winning amount comprises:
increase the displayed winning amount when the dial interface is turned the first direction; and
decrease the displayed winning amount when the dial interface is turned the second direction;
receive a confirmation of the winning amount, wherein receiving confirmation of the wager amount comprises receiving a second push at the dial interface; and
in response to receiving the confirmation of the winning amount, displaying a first wagering combination.

2. The kiosk of claim 1, wherein the first direction is clockwise, and the second direction is counterclockwise.

3. The kiosk of claim 1, wherein the first direction is counterclockwise, and the second direction is clockwise.

4. The kiosk of claim 1, wherein the dial interface is a physical dial attached to the sports betting kiosk.

5. The kiosk of claim 4, wherein the dial interface is a physical dial interface comprising:
a display; and
a round exterior portion coupled to the display, the round exterior portion operable to rotate around the display.

6. The kiosk of claim 5, wherein the physical dial interface is operable to receive a confirmation when the round exterior portion is depressed.

7. The kiosk of claim 5, wherein the physical dial interface is operable to adjust an amount when the round exterior portion is rotated around the display.

8. The kiosk of claim 1, further comprising:
at least one processor; and
memory comprising computer executable instructions that, when executed by the at least one processor; cause the at least one processor to perform operations comprising:
receive the wager amount and the wining amount via the dial interface;
retrieve available betting opportunities;
generate a plurality of wager combinations that achieve the winning amount; and
cause display of a subset of the wagering combinations, wherein the subset of winning combinations includes the first wagering combination.

9. The kiosk of claim 1, wherein the dial interface is a digital dial interface.

10. A sports betting kiosk operable to receive wagers on sporting events, the sports wagering kiosk comprising:
a first display; and
a dial interface comprising, wherein the dial interface is operable to:
receive a wager amount via a turn of the dial interface, wherein receiving the wager amount comprises:
increasing the wager amount when the dial interface is turned a first direction; and
decreasing the wager amount when the dial interface is turned a second direction;
receive confirmation of a wager amount, wherein receiving confirmation of the wager amount comprises receiving a first push at the dial interface;
in response to receiving the wager amount, receive a winning amount, wherein receiving the winning amount comprises:
increase the displayed winning amount when the dial interface is turned the first direction; and
decrease the displayed winning amount when the dial interface is turned the second direction;
receive a confirmation of the winning amount, wherein receiving confirmation of the wager amount comprises receiving a second push at the dial interface; and
in response to receiving the confirmation of the winning amount, displaying a first wagering combination, wherein the first wager combination is displayed on the first display.

11. The sports betting kiosk of claim 4, wherein the dial interface is a physical dial interface comprising:
a second display; and
a round exterior portion coupled to the display, the round exterior portion operable to rotate around the display, wherein the physical dial interface is positioned proximate to the first display.

12. The sports kiosk of claim 11, wherein the physical dial interface is operable to receive a confirmation when the round exterior portion is depressed.

13. The sports betting kiosk of claim 12, wherein the physical dial interface is operable to adjust an amount when the round exterior portion is rotated around the display.

14. The sports betting kiosk of claim 10, further comprising:
at least one processor; and
memory comprising computer executable instructions that, when executed by the at least one processor; cause the at least one processor to perform operations comprising:
receive the wager amount and the wining amount via the dial interface;
retrieve available betting opportunities;
generate a plurality of wager combinations that achieve the winning amount; and
cause display of a subset of the wagering combinations, wherein the subset of winning combinations includes the first wagering combination.

15. The sports betting kiosk of claim 14, wherein causing display of the subset of wagering combinations further comprises:
causing display of the first wagering combination on the first display and the second display; and
causing display of at this a second wagering combination of the subset of wagering combinations on the first display in addition to the first wagering combination.

16. The sports betting kiosk of claim 15, wherein the dial interface is further operable to”
cycle through wagering combinations from the subset of wagering combinations via rotation of the dial interface; and
select a selected wagering combination upon receiving a third push of the dial interface.

17. The sports betting kiosk of claim 10, wherein the first display is a touchscreen display and wherein the dial interface is a digital dial interface displayed on the first display.

18. A wagering kiosk operable to receive wagers, the wagering kiosk comprising:
at least one processor;
a memory;
a first display; and
a physical dial interface comprising a second display and a round exterior portion coupled to the display, the round exterior portion operable to rotate around the display, wherein the physical dial interface is operable to:
receive a wager amount via a turn of the dial interface, wherein receiving the wager amount comprises:
increasing the wager amount when the dial interface is turned a first direction; and
decreasing the wager amount when the dial interface is turned a second direction;
receive confirmation of a wager amount, wherein receiving confirmation of the wager amount comprises receiving a first push at the dial interface;
in response to receiving the wager amount, receive a winning amount, wherein receiving the winning amount comprises:
increase the displayed winning amount when the dial interface is turned the first direction; and
decrease the displayed winning amount when the dial interface is turned the second direction;
receive a confirmation of the winning amount, wherein receiving confirmation of the wager amount comprises receiving a second push at the dial interface;
in response to receiving the confirmation of the winning amount, causing display of a first wagering combination, wherein the first wager combination is displayed on the first display; and
wherein the memory comprises computer executable instructions that, when executed by the at least one processor; cause the at least one processor to perform operations comprising:
receive the wager amount and the wining amount via the dial interface;
retrieve available betting opportunities;
generate a plurality of wager combinations that achieve the winning amount; and
cause display of a subset of the wagering combinations, wherein the subset of winning combinations includes the first wagering combination.

19. The wagering kiosk of claim 18, wherein the first direction is clockwise, and the second direction is counterclockwise.

20. The wearing kiosk of claim 19, wherein the physical dial interface is operable to receive a confirmation when the round exterior portion is depressed.
